(19) United States
(12) Patent Application Publication
(10) Pub. No.: US 2014/0156801 A1
(43) Pub. Date: Jun. 5, 2014

(54) COWATCHING AND CONNECTED PLATFORMS USING A PUSH ARCHITECTURE

(71) Applicant: MOBITV, INC., Emeryville, CA (US)

(72) Inventors: Cedric Fernandes, San Ramon, CA (US); Kent Karlsson, Berkeley, CA (US); Kendall Li, San Francisco, CA (US); Anders Odlund, San Francisco, CA (US)

(73) Assignee: MobiTv, Inc., Emeryville, CA (US)

(21) Appl. No.: 13/693,159

(22) Filed: Dec. 4, 2012

(51) Int. Cl. H04L 29/08

(52) U.S. Cl. CPC H04L 67/26
USPC 709/219

(57) ABSTRACT

Techniques and mechanisms are described herein for facilitating cowatching and connected platforms using a push architecture. According to various embodiments, a first message from a first client device may be received at a server. The first message may include first update information for updating first shared media context information at the server. The server may be operable to provide a shared media environment across a plurality of client devices based on the first shared media context information. The plurality of client devices may include the first client device and a second client device. The first message may be transmitted via a push communications framework. The first shared media context information may be updated based on the first message. A second message may be transmitted to the second client device via the push communications framework. The second message may include second update information.

### TECHNICAL FIELD

The present disclosure relates to connected multi-screen media applications.

### DESCRIPTION OF RELATED ART

A variety of devices in different classes are capable of receiving and playing video content. These devices include tablets, smartphones, computer systems, game consoles, smart televisions, and other devices. The diversity of devices combined with the vast amounts of available media content has created a number of different presentation mechanisms and user-interaction paradigms. For instance, devices differ in terms of form factor, portability, touch control capabilities, computing capabilities, communications capabilities, and other such features. However, mechanisms for providing common experiences across different device types and content types are limited. Techniques described herein allow users to have improved experiences across devices and content types.

### BRIEF DESCRIPTION OF THE DRAWINGS

The disclosure may best be understood by reference to the following description taken in conjunction with the accompanying drawings, which illustrate particular embodiments.

FIGS. 1, 2, 3A, and 3B illustrate examples of systems that can be used with various techniques and mechanisms of the present invention.

FIG. 4 illustrates one technique for providing connected platforms using a push architecture.

FIG. 5 illustrates one technique for transmitting a context update push message.

FIG. 6 illustrates one technique for receiving a context update push message.

FIGS. 7-10 illustrate examples of user interfaces.

FIG. 11 illustrates one example of a system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Disclosed herein are mechanisms and techniques that may be used to provide a connected, multi-screen media content application. According to various embodiments, applications and devices interacting in a connected platform may have access to a shared context for distributing and accessing information used to provide the connected platform. A change to the context in one portion of the connected platform may cause an application or device in another portion of the connected platform to update or perform an action. Accordingly, the platform may include a fast and efficient mechanism for notifying applications and devices of a change to the context. Context change notifications may be transmitted among different portions of the connected platform via a push messaging architecture. In a push messaging architecture, the request for a given communications transaction is initiated by the transmitter of the message.

### Example Embodiments

According to various embodiments, a connected multi-screen system may provide a common experience across devices while allowing multi-screen interactions and navigation. Content may be organized around content entities such as shows, episodes, sports categories, genres, etc. The system includes an integrated and personalized guide along with effective search and content discovery mechanisms. Co-watching and companion information allow for uses such as device control, user presence and device detection, application upgrading, social interactivity, and metadata exploration.

According to various embodiments, a connected multi-screen interface is provided to allow for a common experience across devices in a way that is optimized for various device strengths. Media content is organized around media entities such as shows, programs, episodes, characters, genres, categories, etc. In particular embodiments, live television, on-demand, and personalized programming are presented together. Multi-screen interactions and navigation facilitate activities such as social interactivity, metadata exploration, accessing show information, and presenting reviews.

According to various embodiments, a connected multi-screen interface may be provided on two or more display screens associated with different devices. The connected interface may provide a user experience that is focused on user behaviors, not on a particular device or service. In particular embodiments, a user may employ different devices for different media-related tasks. For instance, a user may employ a television to watch a movie while using a connected tablet computer to search for additional content or browse information related to the movie.

According to various embodiments, when various media-related devices and applications are “connected” in a converged media platform, the advantages of different devices and the context of associated applications may be leveraged to affect other applications within the platform. For instance, when a user is watching a specific program or interacting with her collection of media on a set top box, this detailed information can be shared with an application running on that user's mobile phone and/or tablet computer. With this sharing of information, the mobile application can now leverage the device's connectivity, physical/touch interface, and/or proximity to the user to present a streamlined interface for navigation and discovery that is highly relevant to the user and their current activity. When a user discovers media that they would like to view, the user can choose the playback device using, for instance, intuitive touch gestures to initiate playback on the targeted device. Once this playback has initiated, this feedback can once again be relayed throughout the platform to continue the interaction cycle.

According to various embodiments, devices and applications may access a shared context that facilitates the sharing and distribution of information, such as information used to provide a connected platform. The shared context may include a number of topics. Each topic may include any information or instructions for establishing the connected user interface, such as information shared among different devices and/or applications. For instance, a topic may include information representing a specific property or group of properties of the shared context. Examples of such a property may include, but are not limited to: as the identity of a content channel currently being viewed, the identity of the user of a device, and the identity of a content item being presented on one or more of the devices.

According to various embodiments, a connected platform may employ a push architecture to provide access to the shared context. Push, or server push, describes a style of Internet-based communication where the request for a given transaction is initiated by the publisher or central server. Push architecture is contrasted with pull, or poll, architecture where the request for the transmission of information is initiated by the receiver or client. In a push architecture, applications or devices responsible for changes to the shared context may publish messages to one or more topics. These messages may then be pushed out to other applications and/or devices that subscribe to the one or more topics. In this way, a potentially wide variety of applications across different devices may manipulate and/or react to a shared context to interact via a connected platform. The connected user interface may potentially be used to support many different types of connections and interactions, from one-way two-device interactions to multi-way, multi-device, multi-application interactions.

In particular embodiments, a push architecture may be simulated by using a poll architecture. For example, an application may conduct repeated and frequent polling, polling a server once per second or once every few seconds. As another example, a hybrid framework such as long polling may be used. Long polling is a variation of the traditional polling technique and allows emulation of an information push from a server to a client. With long polling, the client requests information from the server in a similar way to a normal poll. However, if the server does not have any information available for the client, instead of sending an empty response, the server may hold the request and waits for some information to be available. Once the information becomes available (or after a suitable timeout), a complete response is sent to the client. The client may then re-request information from the server, so that the server will almost always have an available waiting request that it can use to deliver data in response to an event. Accordingly, in some embodiments the term “push architecture” as used herein may refer to a traditional push architecture, while in other embodiments the term may also encompass other message passing frameworks used to simulate a traditional push architecture.

According to various embodiments, a connected platform may be used to access, search, present, or identify related information across different devices and/or applications. For instance, a user may be viewing media content such as a movie or a live sporting event on a television via a set top box. Then, an advertisement may be presented on the television screen. The user may also be using a tablet computer and may wish to view more information regarding content that was presented in the advertisement or the sporting event. To access additional information, the user may activate a button or other affordance on the tablet computer. The application on the tablet computer may then transmit a message to a server for receiving additional information related to the media content or advertisement presented on the television.

According to various embodiments, the connected platform may be used to provide command and control functionality. For example, a device such as a mobile phone or tablet computer may be used to change a channel, select a content item for presentation, or control the volume. In some instances, such control instructions may be transmitted to a particular device, such as a television or set top box. Alternately, control instructions may be transmitted to many or all devices within the connected platform. For instance, a user may close all media applications, mute all audio volume, or issue other such commands to all devices and applications from a single device, such as a mobile phone.

According to various embodiments, the connected platform may be used to detect user and device presence. For example, when a device joins a network, the connected platform may identify the device and determine whether to add the device to the connected platform and/or a shared context. The connected platform may determine whether the new device is accessing a content management account shared with other devices already connected to the platform. As another example, the connected platform may determine the identity of a user of a device such as a tablet computer, television, or mobile phone connected with the platform. The identity may be determined via any of various techniques, which may include, but are not limited to: receiving username and/or password information, identifying an owner or other user associated with the device, receiving an identity selection from the user, and guessing a user identity based on information such as user viewing history and preference data.

According to various embodiments, the connected platform may be used to transmit upgrades or updates to applications or devices on the connected platform. For instance, the devices accessing the connected platform may use similar or different versions of a media application for accessing the connected platform and/or for performing various media-related tasks. When updates to this application are available, notifications regarding the updates or the updates themselves may be transmitted via the connected platform. For instance, the shared context may include application version information topics to which the relevant applications and/or devices may subscribe in order to be informed when the application version information is updated.

According to various embodiments, the connected platform may be used to perform user messaging and transmit chat messages. Depending on the application, various types of messages may be transmitted. For example, a media system services provider may transmit messages to users, such as messages concerning user accounts, advertisements, or service notifications. As another example, different users who share access to a content management account, such as different family members within a household, may transmit messages to each other while using connected devices. As yet another example, users who use different content management accounts but who are sharing a context via the connected platform may chat with each other, for instance while viewing content. As yet another example, users in different locations and who have different content management accounts may transmit chat messages to each other. For instance, the users may be “friends” on a chat interface or may simply be viewing the same content, such as a live sporting event.

According to various embodiments, a connected user interface may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

According to various embodiments, the connected user interface may be used to present a connected personalized content guide. A connected personalized content guide may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

According to various embodiments, the connected user interface may be used to present a social media application on one or more devices. A social media application may facilitate the exchange of user-generated content. The user-generated content may be related to media content accessed via the media system. For instance, the user-generated content may include comments, recommendations regarding content, ratings of content, and other such content. The social media application may be provided by the media system or by a third party, such as a social networking service. In some instances, the social media application may facilitate interaction via a standalone social media system provided by the connected user interface provider. Alternately, or additionally, the social media application may facilitate interaction via a third party social media system such as YouTube, Twitter, or Facebook.

According to various embodiments, the connected user interface may be used to access media content presented in a way that reflects a media content data structure. A media content data structure may be created to provide structure and organization to media content. The media content data structure may include media content assets and media content entities. A media content asset may be any media content item that may be presented to a user via a media presentation device. For example, a media content asset may be a television episode, movie, song, audio book, radio program, or any other video and/or audio content. A media content entity may be any category, classification, or container that imposes structure on the media content assets. In particular embodiments, a media content entity may include media content assets and other media content entities. For example, a media content entity may correspond to a television program, a particular season of a television program, a content genre such as “dramas”, a series of movies, a director or cast member, or any other category or classification.

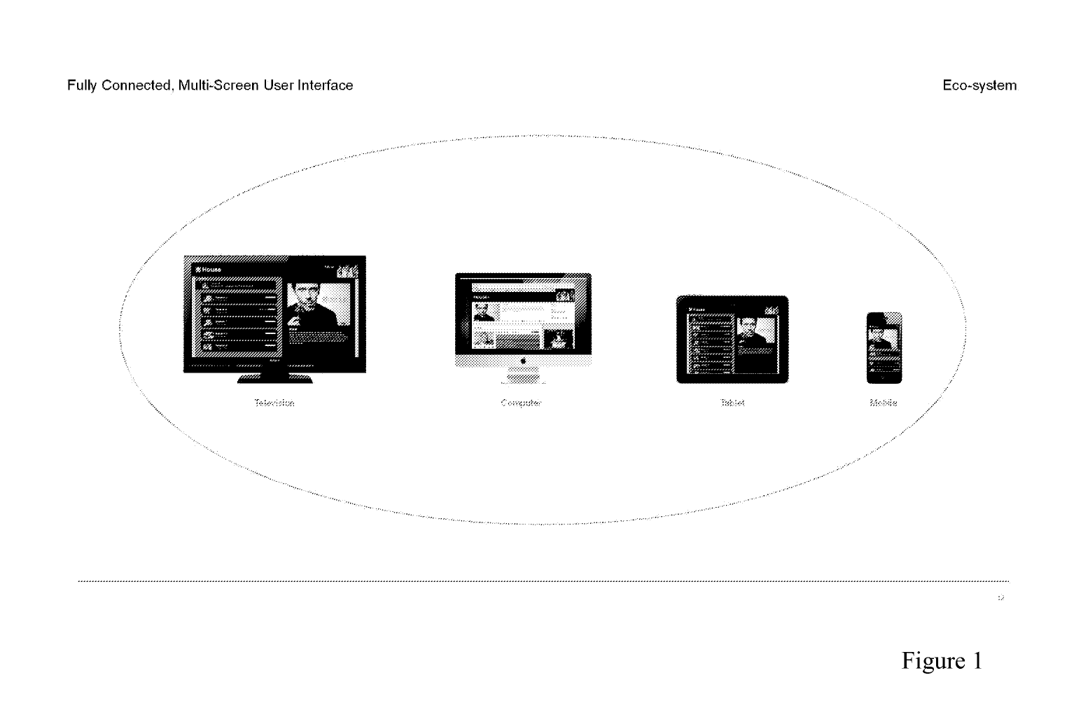

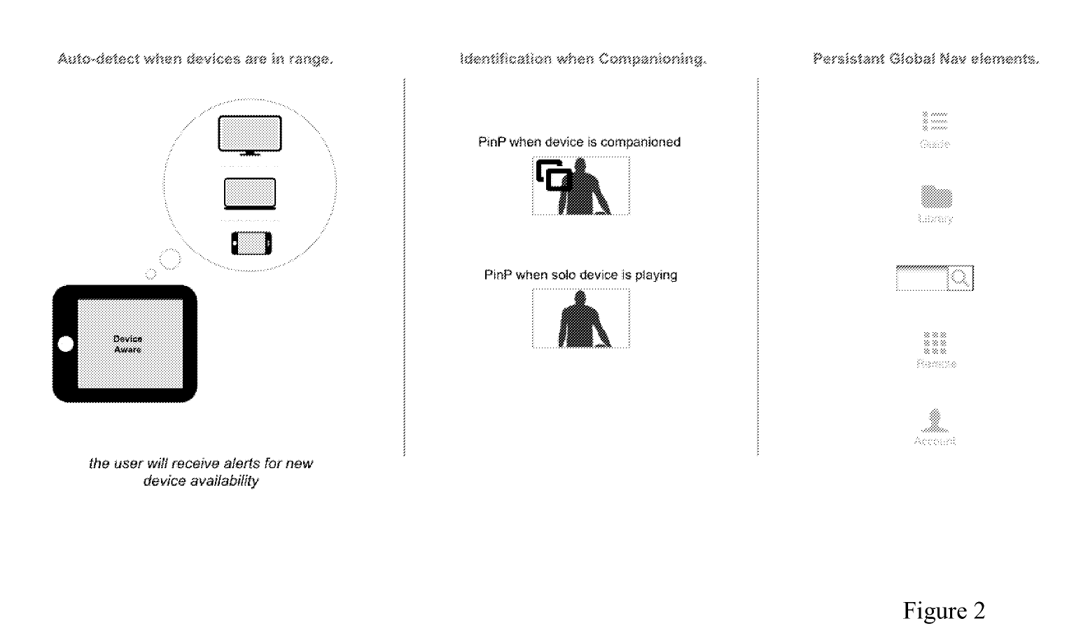

FIGS. 1 and 2 illustrate examples of systems that can be used with various techniques and mechanisms of the present invention. As shown in FIG. 1, various devices may be used to view a user interface for presenting and/or interacting with content. According to various embodiments, one or more conventional televisions, smart televisions, desktop computers, laptop computers, tablet computers, or mobile devices such as smart phones may be used to view a content-related user interface. Devices may differ in terms of form factor, portability, touch control capabilities, computing capabilities, communications capabilities, and other such features.

According to various embodiments, a user interface for presenting and/or interacting with media content may include various types of components. For instance, a user interface may include one or more media content display portions, user interface navigation portions, media content guide portions, related media content portions, media content overlay portions, web content portions, interactive application portions, or social media portions.

According to various embodiments, the media content displayed on the different devices may be of various types and/or derive from various sources. For example, media content may be received from a local storage location, a network storage location, a cable or satellite television provider, an Internet content provider, or any other source. The media content may include audio and/or video and may be television, movies, music, online videos, social media content, or any other content capable of being accessed via a digital device.

As shown in FIG. 2, devices may communicate with each other. According to various embodiments, devices may communicate directly or through another device such as a network gateway or a remote server. In some instances, communications may be initiated automatically. For example, an active device that comes within range of another device that may be used in conjunction with techniques described herein may provide an alert message or other indication of the possibility of a new connection. As another example, an active device may automatically connect with a new device within range.

According to various embodiments, a user interface may include one or more portions that are positioned on top of another portion of the user interface. Such a portion may be referred to herein as a picture in picture, a PinP, an overlaid portion, an asset overlay, or an overlay.

According to various embodiments, a user interface may include one or more navigation elements, which may include, but are not limited to: a media content guide element, a library element, a search element, a remote control element, and an account access element. These elements may be used to access various features associated with the user interface, such as a search feature or media content guide feature.

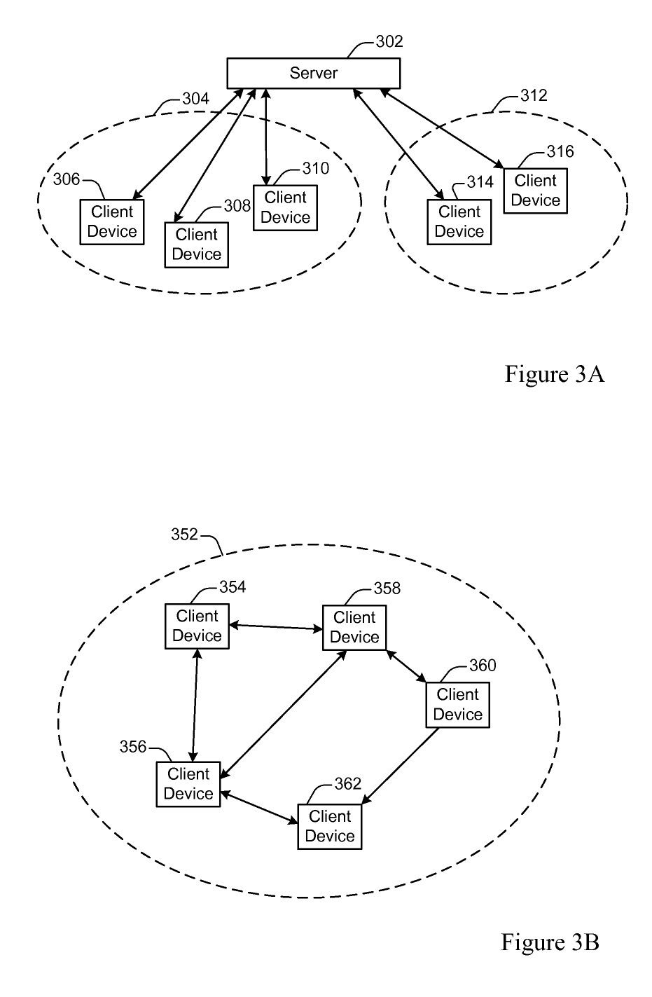

FIG. 3A illustrates an example of a client-server architecture for providing a connected platform. The architecture shown in FIG. 3A includes a server 302 and the shared contexts 304 and 312. The shared context 304 includes the client devices 306-310, while the shared context 312 includes the client devices 314-316. In FIG. 3A, client devices communicate with a shared server to establish and maintain a shared context.

FIG. 3B illustrates an example of a directly connected architecture for providing a connected platform. The architecture shown in FIG. 3B includes a shared context 352 and the client devices 354-362. In FIG. 3B, client devices communicate directly with one another to establish and maintain a shared context.

According to various embodiments, the devices shown in FIGS. 3A and 3B may communicate via any of a variety of communications protocols. For instance, the devices may communicate by protocols that may include, but are not limited to: Hypertext Transfer Protocol (HTTP), Universal Plug and Play (UPNP), Bluetooth, Wi-Fi Direct, and Digital Living Network Alliance (DLNA). The devices may communicate by any of various networks, such as wired and/or wireless WANs and/or LANs.

According to various embodiments, each of the shared contexts 304, 312, and 352 may be used to maintain shared information and transmit instructions between and among the devices included in the context. For instance, the devices may transmit command and control instructions, requests for information, responses to requests for information, identification information, media information, or any other information.

According to various embodiments, each of the shared contexts includes a number of client devices. Each client device may be any of potentially many different types of devices. For instance, a client device may be a television, a set top box, a laptop computer, a desktop computer, a tablet computer, a mobile phone, an e-reader, or any other type of device capable of transmitting or receiving communications. Some or all of the client devices may facilitate the performance of media-related tasks such as presenting media for playback, selecting or browsing media content items, interacting socially with respect to media content items, rating or commenting on media content items, or other such tasks.

According to various embodiments, each context may correspond to a single content management account or may include devices associated with different content management accounts. In particular embodiments, two or more contexts may overlap. For instance, a single device may be associated with two different content management accounts and may join two different contexts. Communication may be conducted primarily within a shared context or may be conducted between devices located in different shared contexts.

In FIG. 3A, the server 302 may perform various operations related to providing a connected platform. For example, the server may perform business logic related to maintaining a shared context. As another example, the server may send and receive messages for updating the shared context. For instance, the server may receive a message from a client device that contains information for updating the shared context. Then, the server may process the message and update one or more properties of the shared context. Next, the server may transmit a message to other devices that subscribe to the shared context and/or the one or more properties to update the shared context at those devices.

In FIG. 3B, at least some client devices communicate with each other rather than through a server. For example, different client devices that are each running a connected media platform application may establish a communication session and a shared context. Then, when an application running at one device performs an action to update a shared context, the application may transmit a message to one or more other devices with which the context is shared so that the shared context may be updated at the other devices.

According to various embodiments, communication between the devices may be conducted via any of various protocols. In some instances, communication may take place via a LAN, such as a LAN located in a user's house. Devices may learn of each other's existence through a network discovery protocol such as UPNP. Alternately, or additionally, devices may communicate directly with each other. Devices may communicate directly via a protocol such as Wi-Fi Direct.

According to various embodiments, any of various communications paradigms may be used to conduct communications sessions. For instance, communications may be conducted via two-way, one-way, broadcast, unicast, or any other paradigm. In some instances, all devices in a shared context may communicate with each other directly or indirectly. Alternately, some devices may not communicate with each other, for instance if the devices do not need to share information.

According to various embodiments, communication between two devices may be conducted directly or may be conducted using another device as an intermediary. For instance, the client devices 354 and 356 shown in FIG. 3B communicate directly. However, the client devices 354 and 362 do not share a direct communication link. Accordingly, the client devices 354 and 362 may in some instances communicate by transmitting messages through one or more of the client devices 356-360.

In particular embodiments, the architectures shown in FIGS. 3A and 3B are not mutually exclusive. For instance, some devices within a shared context may communicate directly with each other, as shown in FIG. 3A. At the same time, some devices within a shared context may communicate with a server, as shown with respect to FIG. 3B. For example, a server may establish a shared context with devices capable of communicating with the server, such as a set top box, a laptop computer that communicates through a wired WAN, and a mobile phone that communicates via a wireless WAN. At the same time, a second mobile phone may join the shared context by establishing a direct communication link with the set top box via a protocol such as Bluetooth, while a tablet computer may join the shared context by communicating with the other devices via a LAN.

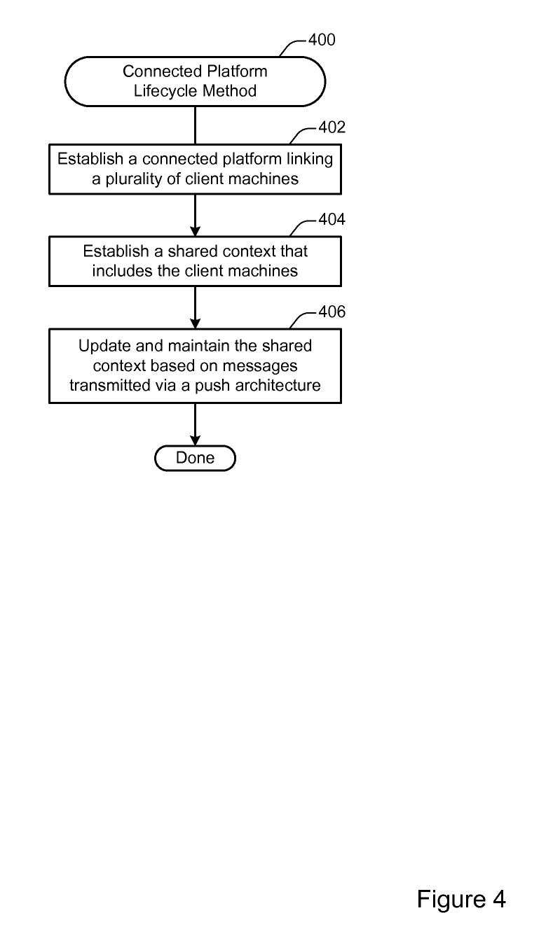

FIG. 4 illustrates a method 400 for providing a connected platform. According to various embodiments, the method 400 may be used to establish, update, and maintain a shared context among a plurality of client machines via a connected platform. The method 400 may be performed at a server, at a client machine, or at a combination of a server and/or one or more client machines.

At 402, a connected platform linking a plurality of client machines is established. According to various embodiments, the connected platform may be used to establish communication sessions with and/or among the client machines. For instance, as discussed with respect to FIGS. 3A and 3B, communications may be conducted between a client machine and a server. Alternately, or additionally, communications may be conducted indirectly or directly between client machines.

According to various embodiments, establishing the connected platform may involve identifying active client devices that are associated with a content management account. For instance, a content management application may be running on a device such as a computer, mobile phone, or set top box. The device may be linked with a content management account by an address, by another type of identifier, by login information, or by some other technique. The device may transmit identifying information to a server or to other devices. The recipient may then use the received information to include the device in the connected platform.

At 404, a shared context that includes the client machines is established. According to various embodiments, establishing the shared context may include performing any operations related to configuring the shared context or linking devices with the shared context. In a first example, topics to include within the shared context may be created and initialized with information based on the types of client devices within the shared context, the types of applications running at the client devices, and the types of actions being performed within those applications. For instance, if a laptop computer is being used to view a particular content item when the shared context is created, the identity of the content item may be stored within the shared context. In a second example, subscriptions to specific topics by particular devices may be established. For instance, each device within the shared context may subscribe to topics that include certain information such as the identity of a content item being presented. At the same time, some devices may not need to subscribe to topics that include other information such as information for establishing a chat session between different devices. In a third example, configuration information for maintaining or updating the shared context may be transmitted to the appropriate devices. For instance, the configuration information may identify recipients of push messages for updating the shared context, communication instructions for communicating between different devices, or business logic describing procedures for updating or maintaining the shared context.

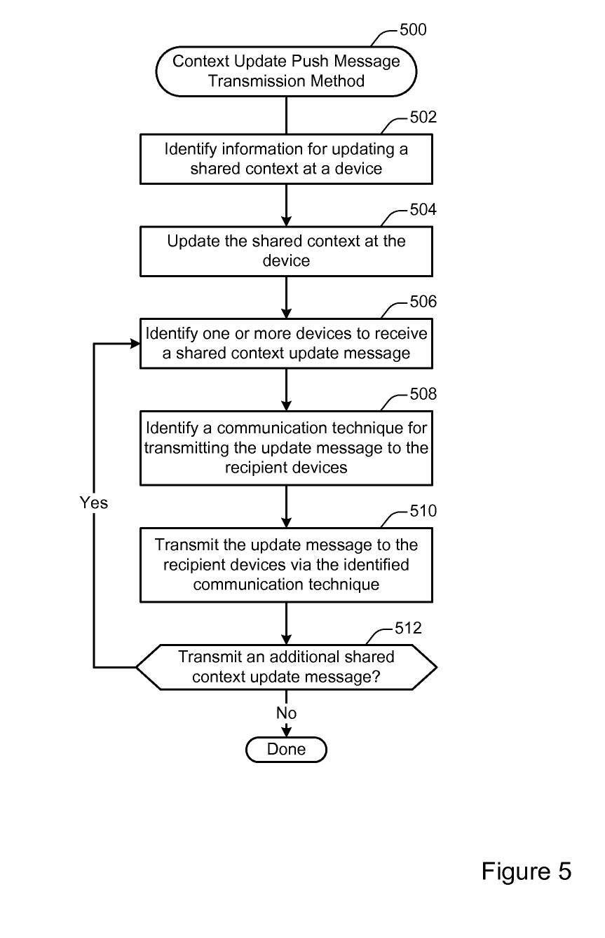

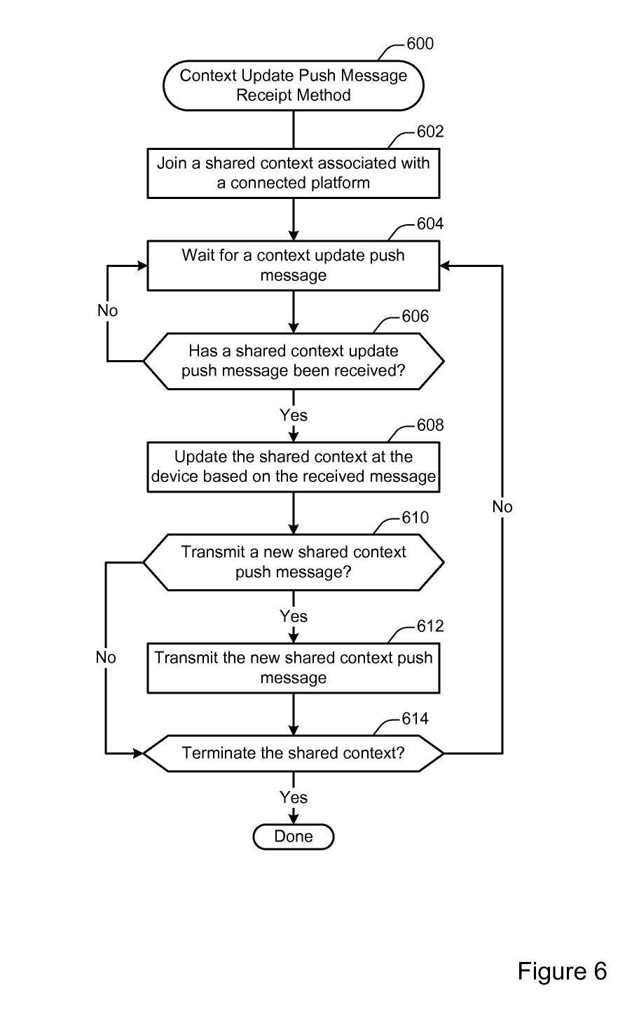

At 406, the shared context is updated and maintained based on messages transmitted via a push architecture. According to various embodiments, the shared context may be updated and maintained by transmitting messages between the devices when changes are made to the shared context. For instance, when new or updated information is received at the server or at one of the client devices, a message may be pushed to any other devices for which the new or updated information is relevant. Techniques for transmitting and receiving push messages between and among various devices are discussed in additional detail with respect to FIGS. 5 and 6.

FIG. 5 illustrates a method 500 for transmitting a context update push message. According to various embodiments, the method shown in FIG. 5 may be used to identify information for updating a shared context, updating the shared context, and transmitting shared context update push messages to one or more other devices for maintaining the shared context and connected platform across the different devices. In particular embodiments, the method 500 may be performed on a client machine, such as one of the client machines discussed with respect to FIGS. 3A and 3B. Alternately, the method 500 may be performed on a server, such as the server 302 discussed with respect to FIG. 3A.

At 502, information for updating a shared context at a device is identified. According to various embodiments, the information may be any data relevant to a topic included in the shared context. For example, the information may be a request to change the channel received at a tablet computer that is sharing a context with a set top box. As another example, the information may be a request received on a mobile phone for information regarding a media content item being presented on a desktop computer. As yet another example, the information may be an application update or an updated media content guide identified at a server managing a context shared among a group of client devices.

At 504, the shared context is updated at the device. According to various embodiments, updating the shared context at the device may involve making a change to a topic included within the shared context. For example, a topic may identify a content channel that is currently being presented. As another example, a topic may identify a volume level shared among the connected devices. As yet another example, a topic may identify one or more users of devices within the shared context. The shared context may be stored in memory or on a storage device at the device. Accordingly, updating the shared context at the device may involve changing one or more of the stored values.

At 506, one or more devices to receive a shared context update push message are identified. According to various embodiments, the devices may be any computing machines within the shared context or configured to maintain the shared context. For instance, a recipient of a shared context update push message may be a server or a different client device.

According to various embodiments, the recipient devices may be identified based on configuration information determined when the shared context is established. For instance, the configuration information may identify which devices are subscribed to which topics included within the shared context. Alternately, or additionally, the configuration information may specify that context update push messages are to be transmitted to a server configured to update and maintain the shared context.

At 508, a communication technique for transmitting the update message to the recipient devices is identified. According to various embodiments, different devices may communicate in different ways. For instance, when communicating with a server, the client machine may transmit a message via a WAN such as a wireless cellular network or a wired communications network. However, when communicating directly with other client devices, the client machine may transmit a message via a local protocol such as Wi-Fi Direct or Bluetooth. The communication technique may be identified by analyzing information determined when the shared context is established. For instance, different devices may establish protocols for communicating between them when updating and maintaining the connected platform.

At 510, the update message is transmitted to the recipient devices via the identified communication technique. According to various embodiments, the update message may include any information for updating the shared context. For instance, the update message may include a request for additional information, an instruction for performing an operation, or a status update. By transmitting the update message, information contained in the shared context may be used to provide a connected platform across the different devices.

In particular embodiments, a recipient device may perform any of various processing operations when the message is received. For example, the recipient device may update the shared context at the recipient device. As another example, the recipient device may forward the update message to another device. As yet another example, the recipient device may transmit a response back to the sending device. Techniques for processing a received context updated push message are discussed in additional detail with respect to FIG. 6.

At 512, a determination is made as to whether to transmit an additional shared context update message. According to various embodiments, the determination may be made based on any of various factors, such as which devices are part of the shared context, which communication techniques are suitable for use in communicating with different devices, and which devices need particular types of information. For example, a change to the shared context may be made by updating several different topics. Some devices may subscribe to some of the topics but not to others. Accordingly, messages with different update information may be sent to different devices. As another example, one device may communicate via one communication protocol, while another device may communicate via another communication protocol. In this case, messages may be sent to these devices via different communication techniques.

FIG. 6 illustrates a method 600 for receiving a context update push message. According to various embodiments, the method shown in FIG. 6 may be used to receive and process a context update push method to update a shared context and/or transmit new shared context push messages. In particular embodiments, the method 600 may be performed on a client machine, such as one of the client machines discussed with respect to FIGS. 3A and 3B. Alternately, the method 600 may be performed on a server, such as the server 302 discussed with respect to FIG. 3A.

At 602, a shared context associated with a connected platform is joined. As discussed with to FIG. 4, a shared context may be established among potentially many different client devices. The devices may communicate directly or indirectly to update and maintain the shared context. When the shared context is joined, configuration and communication information for updating and maintaining the shared context may be received or determined at the device performing the method 600.

At 604, the device waits for a context update push message. According to various embodiments, the device may be prepared to receive messages via any of a variety of communications protocols. By waiting for a push message instead of employing a polling framework, the shared context may be updated more quickly. As discussed with respect to FIG. 5, a message may be pushed to the recipient device when new information for updating the shared context is received or determined. The recipient device may subscribe to or manage a topic within the shared context that includes information related to the push message.

At 606, a determination is made as to whether a shared context update push message has been received. If no message is received, then monitoring may continue. If instead a message is received, then the message is processed as described with respect to operation 608.

At 608, the shared context is updated at the device based on the received message. According to various embodiments, updating the shared context may involve any number of a variety of different operations related to providing a common media experience across a number of different connected devices. These operations may include, but are not limited to, updating values stored in memory or on a storage device, performing data processing operations, requesting information from other devices via a network, transmitting messages to other devices within the shared context, and transmitting a response message to the device from which the context update push message was received.

In a first example, the shared context may be updated by changing or establishing a value stored in memory. For instance, the shared context may be updated by changing the identity of content currently being presented, changing a status value, changing a value identifying a user identity, or changing any other information.

In a second example, changing the shared context may involve performing business logic. For instance, the context update push message may include a request to send a chat message to a recipient at a different device. The business logic may then identify the chat session, determine the recipient device, and transmit a chat message to the recipient device.

In a third example, changing the shared context may involve creating a response to the received context update push message. For instance, the message may include a request for information related to content being presented. The receiving device may then identify the content being presented, determine information related to the content, and transmit the content to the requesting device or to a different device within the shared context.

At 610, a determination is made as to whether to transmit a new shared context push message. According to various embodiments, a new shared context push message may be transmitted for any of various reasons.

In a first example, method 600 may be performed at a server configured to manage a shared context. When information is received from one of the devices in the context via a push message, the information may then be pushed out to other devices within the shared context.

In a second example, as discussed with respect to FIG. 3B, two devices within a shared context may not be configured to communicate directly and may instead communicate indirectly via a third device. In this case, the third device may receive a shared context push message from one device and forward the information on to the second device.

In a third example, the new shared context push message may include a response to the original message. For instance, the original message may include a request for information related to a content item presented on a different device. The server may then identify the content item, locate the related information, and transmit the information to the original requesting device or to another device.

At 612, the new shared context push message is transmitted to one or more recipients. According to various embodiments, the techniques used to transmit the new shared context push message may be substantially similar to the techniques discussed with respect to FIG. 5. For instance, a recipient device for receiving the message along with a communication technique for communicating with the recipient device may be identified based on configuration information.

At 614, a decision is made as to whether to terminate the shared context. According to various embodiments, the shared context may be terminated when a request to terminate the shared context is received. Such a request may be received at the device at which the method 600 shown in FIG. 6 is performed. Alternately, such a request may be received at a different device. For instance, a request to terminate the shared context and de-link the devices communicating via the connected platform may be received at another device, such as a computer, mobile phone, or television within the shared context. If the context is not terminated, then the device may continue to monitor for push messages.

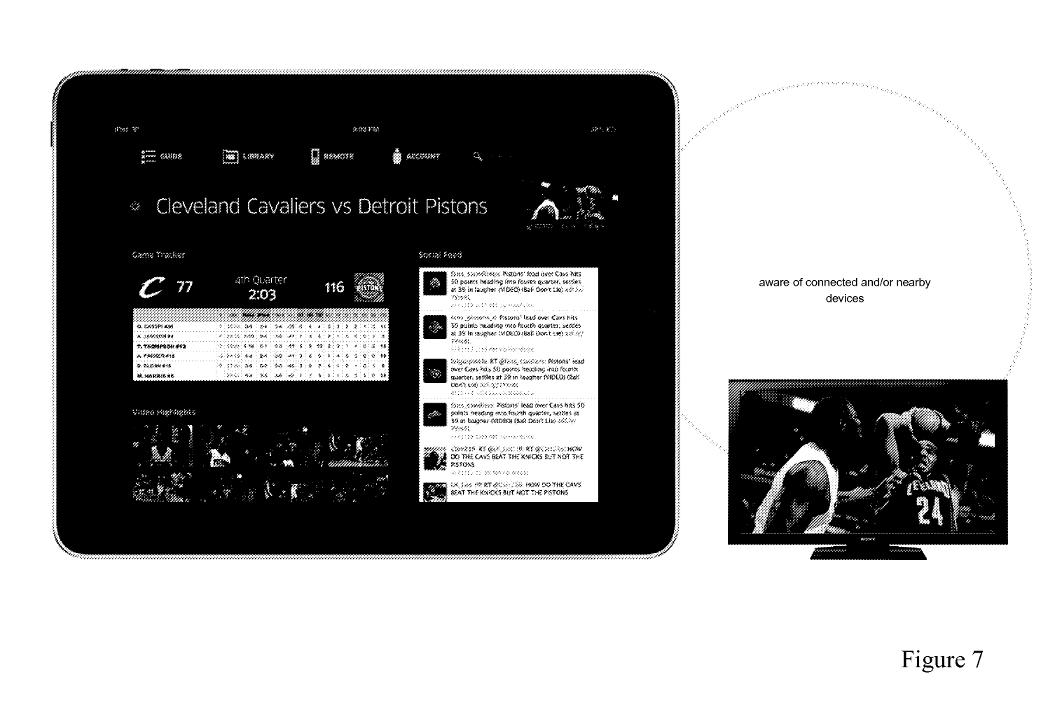

FIGS. 7-10 illustrate images of examples of a connected user interface displayed across two devices. According to various embodiments, the user interfaces shown may be presented on any of various devices. In some cases, user interfaces may appear somewhat differently on different devices. For example, different devices may have different screen display resolutions, screen display aspect ratios, and user input device capabilities. Accordingly, a user interface may be adapted to a particular type of device.

In FIG. 7, the tablet computer is configured for companion viewing. In companion viewing mode, the tablet computer may display information related to the content displayed on the television. For instance, in FIG. 7, the tablet computer is displaying the score of the basketball game, social media commentary related to the basketball game, video highlights from the game, and play statistics. In addition, the tablet computer displays a smaller, thumbnail image sized video of the content displayed on the television.

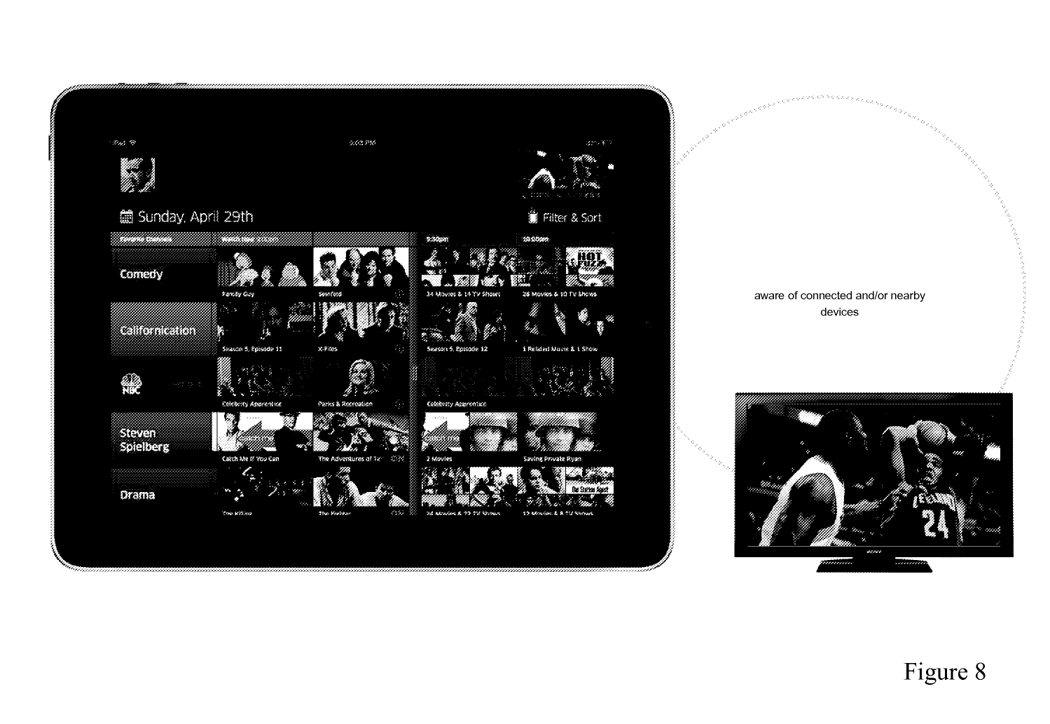

In FIG. 8, the user browses for new content while continuing to view the basketball game in companion mode across the two devices. Accordingly, the tablet computer displays a content guide for selecting other content while continuing to display the smaller, thumbnail image sized video of the basketball game displayed on the television.

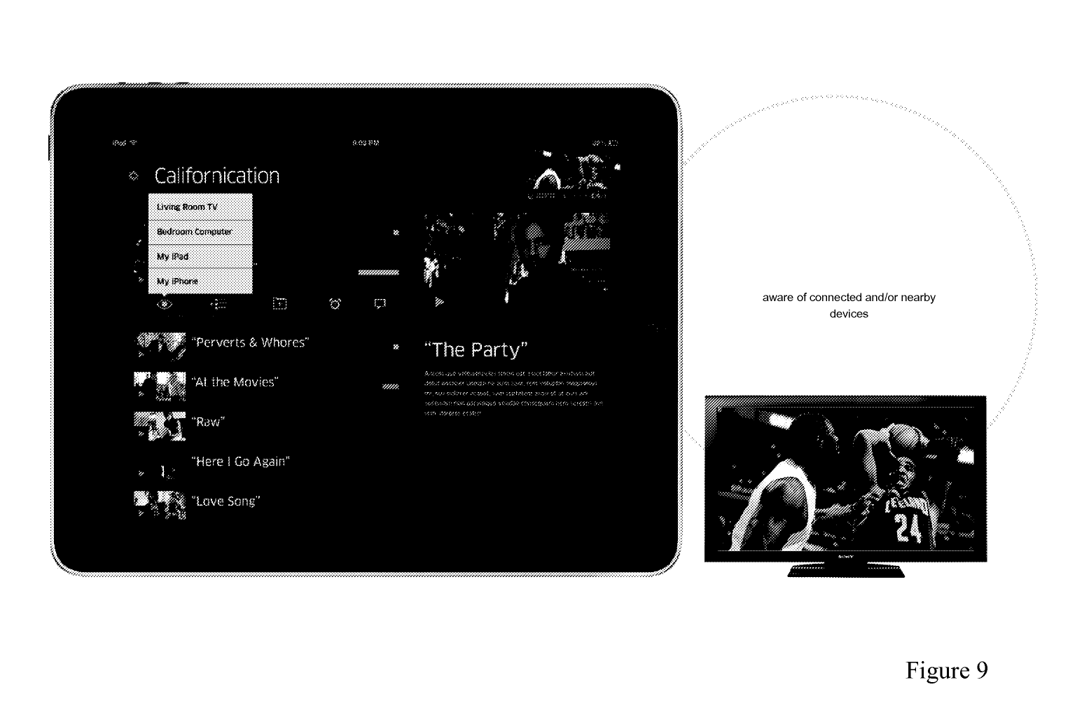

In FIG. 9, the user is in the process of selecting a new media content item for display. Here the new media content item is a television episode called “The Party.” After selecting the media content item, the user may select a device for presenting the content. In FIG. 9, the available devices for selection include the Living Room TV, the Bedroom Computer, My iPad, and My iPhone. By allowing control of content across different devices, the connected user interface can provide a seamless media viewing experience.

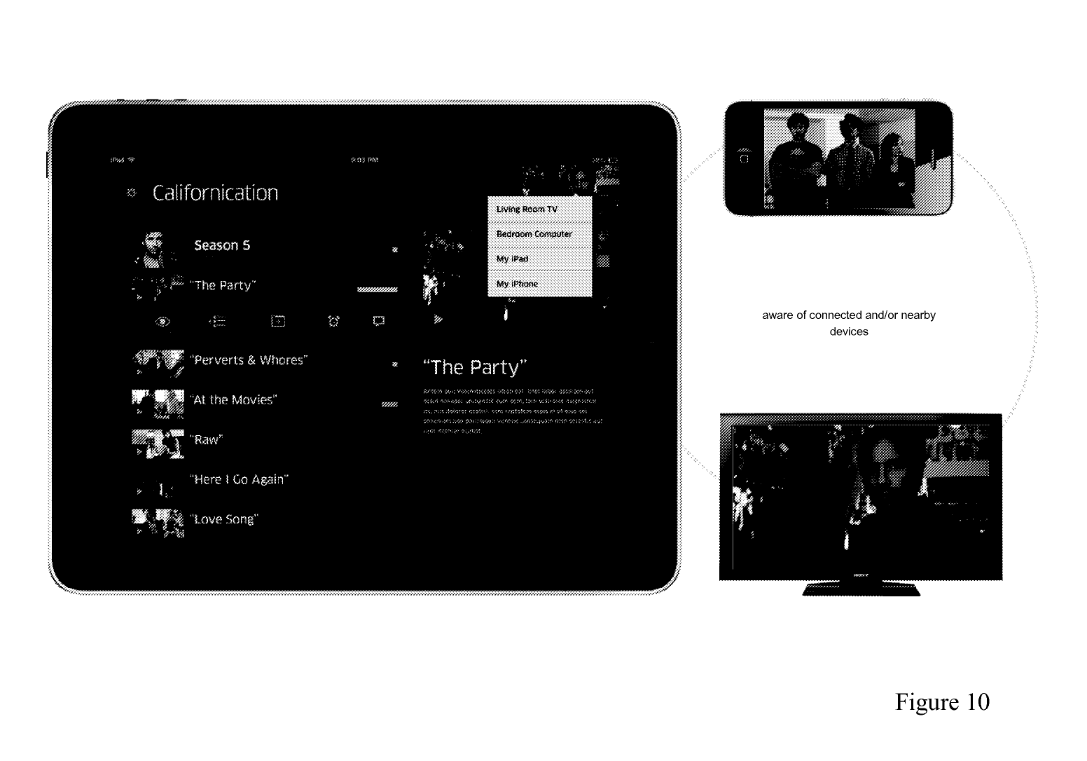

In FIG. 10, the user has selected to view the new television program on the Living Room TV. Additionally, a new device, which is a mobile phone, has entered the set of connected and/or nearby devices. By selecting the device within the user interface, the user can cause the currently playing video to also display on the mobile phone. In this way, the user can continue a video experience without interruption even if the user moves to a different physical location. For example, a user may be watching a television program on a television while viewing related information on a tablet computer. When the user wishes to leave the house, the user may cause the television program to also display on a mobile phone, which allows the user to continue viewing the program.

It should be noted that the user interfaces shown in FIGS. 7-10 are only examples of user interfaces that may be presented in accordance with techniques and mechanisms described herein. According to various embodiments, user interfaces may not include all elements shown in FIGS. 7-10 or may include other elements not shown in FIGS. 7-10. By the same token, the elements of a user interface may be arranged differently than shown in FIGS. 7-10. Additionally, user interfaces may be used to present other types of content, such as music, and may be used in conjunction with other types of devices, such as personal or laptop computers.

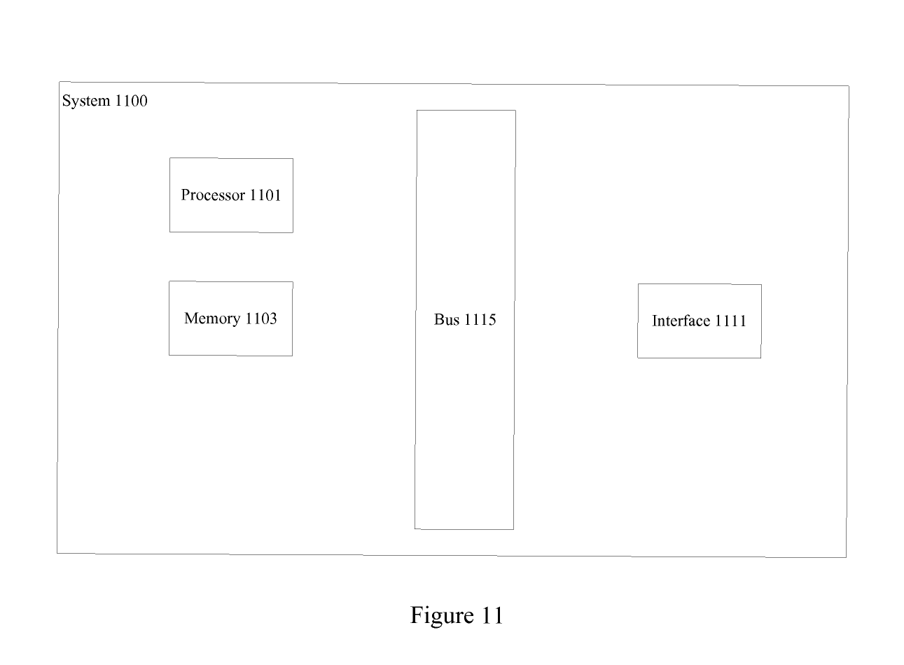

FIG. 11 illustrates one example of a server. According to particular embodiments, a system 1100 suitable for implementing particular embodiments of the present invention includes a processor 1101, a memory 1103, an interface 1111, and a bus 1115 (e.g., a PCI bus or other interconnection fabric) and operates as a streaming server. When acting under the control of appropriate software or firmware, the processor 1101 is responsible for modifying and transmitting live media data to a client. Various specially configured devices can also be used in place of a processor 1101 or in addition to processor 1101. The interface 1111 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 1100 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
receiving, at a server, a first message from a first client device, the first message including first update information for updating first shared media context information at the server, the server being operable to provide a shared media environment across a plurality of client devices based on the first shared media context information, the plurality of client devices including the first client device and a second client device, the first message being transmitted via a push communications framework;
updating the first shared media context information based on the first message; and
transmitting a second message to the second client device via the push communications framework, the second message including second update information for updating second shared media context information at the second client device.

2. The method recited in claim 1, wherein updating the first shared media context information comprises:
updating a data value corresponding to a first setting associated with providing the shared media environment; and
identifying one or more client devices to receive an update message including an indication of the updated data value, the identified one or more client devices including the second client device.

3. The method recited in claim 1, wherein each of the first and second client devices is configured to present a media presentation interface, wherein the media presentation interface at the second media presentation device is configured to display a media content item, and wherein the media presentation interface at the first media presentation device is configured to display contextual information related to the media content item.

4. The method recited in claim 1, wherein the second client device is operable to receive and present a television transmission, and wherein the shared context update push message comprises a selection of a designated television channel to present at the second client device.

5. The method recited in claim 1, wherein the shared context update push message comprises an instruction designating an operation to perform at the second client device.

6. The method recited in claim 1, wherein the shared context update push message comprises a request for media information to present at the second client device, the media information selected from the group consisting of: a media content item and contextual information relating to a media content item.

7. The method recited in claim 6, wherein the media content item is capable of being viewed on a plurality of computing devices associated with the content management account, and wherein the plurality of computing devices includes the first and second client machines.

8. The method recited in claim 1, wherein the shared context update push message comprises a request to conduct an interaction with the second client device via a social media application.

9. A system comprising:
a storage device operable to store first shared media context information at the server, the system being operable to provide a shared media environment across a plurality of client devices based on the first shared media context information, the plurality of client devices including the first client device and a second client device, the first message being transmitted via a push communications framework;
update the first shared media context information based on a first message received from a first client device; and
a communications interface operable to transmit a second message to the second client device via the push communications framework, the second message including second update information for updating second shared media context information at the second client device.

10. The system recited in claim 9, wherein updating the first shared media context information comprises:
updating a data value corresponding to a first setting associated with providing the shared media environment; and
identifying one or more client devices to receive an update message including an indication of the updated data value, the identified one or more client devices including the second client device.

11. The system recited in claim 9, wherein each of the first and second client devices is configured to present a media presentation interface, wherein the media presentation interface at the second media presentation device is configured to display a media content item, and wherein the media presentation interface at the first media presentation device is configured to display contextual information related to the media content item.

12. The system recited in claim 9, wherein the second client device is operable to receive and present a television transmission, and wherein the shared context update push message comprises a selection of a designated television channel to present at the second client device.

13. The system recited in claim 9, wherein the shared context update push message comprises an instruction designating an operation to perform at the second client device.

14. The system recited in claim 9, wherein the shared context update push message comprises a request for media information to present at the second client device, the media information selected from the group consisting of: a media content item and contextual information relating to a media content item.

15. The system recited in claim 14, wherein the media content item is capable of being viewed on a plurality of computing devices associated with the content management account, and wherein the plurality of computing devices includes the first and second client machines.

16. The system recited in claim 9, wherein the shared context update push message comprises a request to conduct an interaction with the second client device via a social media application.

17. One or more computer readable media having instructions stored thereon for performing a method, the method comprising:
receiving, at a server, a first message from a first client device, the first message including first update information for updating first shared media context information at the server, the server being operable to provide a shared media environment across a plurality of client devices based on the first shared media context information, the plurality of client devices including the first client device and a second client device, the first message being transmitted via a push communications framework;
updating the first shared media context information based on the first message; and
transmitting a second message to the second client device via the push communications framework, the second message including second update information for updating second shared media context information at the second client device.

18. The one or more computer readable media recited in claim 17, wherein updating the first shared media context information comprises:
updating a data value corresponding to a first setting associated with providing the shared media environment; and
identifying one or more client devices to receive an update message including an indication of the updated data value, the identified one or more client devices including the second client device.

19. The one or more computer readable media recited in claim 17, wherein each of the first and second client devices is configured to present a media presentation interface, wherein the media presentation interface at the second media presentation device is configured to display a media content item, and wherein the media presentation interface at the first media presentation device is configured to display contextual information related to the media content item.

20. The one or more computer readable media recited in claim 17, wherein the second client device is operable to receive and present a television transmission, and wherein the shared context update push message comprises a selection of a designated television channel to present at the second client device.
